(19) United States
(12) Patent Application Publication
(10) Pub. No.: US 2007/0119081 A1
(43) Pub. Date: May 31, 2007

(54) WHEEL COVER

(76) Inventor: Kameyama Kazunao, Tokyo (JP)

Correspondence Address: RANKIN, HILL, PORTER & CLARK LLP, 4080 ERIE STREET, WILLOUGHBY, OH, 44094-7836, US

(21) Appl. No.: 11/562,786

(22) Filed: Nov. 22, 2006

(30) Foreign Application Priority Data
Nov. 25, 2005 (JP) 2005-339677
May 29, 2006 (JP) 2006-147602

(51) Int. Cl. G09F 21/04

(52) U.S. Cl. 40/587

(57) ABSTRACT

A wheel cover comprising: an electric decorator supported so as to be rotatable relative to a wheel-cover main body in such a manner as to substantially not rotate due to rotation of the wheel-cover main body; and a power supply, wherein the electric decorator comprises a display plate having a base member with a desired optical transparency and a refractive index n₁, a characteristic portion having a refractive index n₂ smaller than the refractive index n₁ of the base member being formed in the base member, and a light source for emitting light when supplied with the electrical power from the power supply and for transmitting the light through the interior of the display plate, and the characteristic portion of the display plate shines more intensely with internal illumination of the display plate by the light source than a non-characteristic portion of the base member.

### RELATED APPLICATIONS

This application claims priority to the Japanese Patent Application 2005-339677 dated on Nov. 25, 2005 and the Japanese Patent Application 2006-147602 dated on May 29, 2006, and is hereby incorporated with reference for all purposes.

1. Field of the Invention

The present invention relates to wheel covers, and more particularly, to an improvement in electric decoration thereof.

2. Description of the Related Art

In the related art, in moving bodies provided with wheels, such as automobiles, wheel covers are mounted to the outer sides of the wheels to act as mud guards, to provide a visual design, and to reduce wind resistance.

Recently, there have been demands for applying decoration to the moving bodies.

One approach to satisfy such demands is to provide the wheel covers on these moving bodies with electric decoration.

One example of electric decorator in a wheel cover of the related art includes a light source and a power supply for supplying electrical power to the light source (for example, see Japanese Unexamined Patent Application Publication No. Sho-63-277452).

The wheel cover of the related art provides decoration by making the light source shine by supplying it with electrical power from the power supply.

In this type of wheel cover, however, even though decoration is achieved by providing the electric decoration, there is still some scope for improving the display performance, such as the ease of viewing.

More specifically, because the wheel cover is provided on a moving body, it is extremely important to make it easier to see the decoration thereof, compared with a case where it is provided on a stationary body.

In order to improve the viewability of the electric decoration, one approach considered in the related art is to provide a large display device and power supply in the wheel cover.

However, providing a large display device in the wheel cover greatly increases the total weight of the wheel cover, as well as the size and electrical power consumption. These weight, size, and power consumption problems become even more serious particularly in a wheel cover provided on a moving body.

Thus, such a large display device is not suitable as a solution to these problems.

Despite the need to improve the display performance of the electric decoration on the wheel cover, electric decoration has just added decoration and no technology suitable for improving the display performance thereof has yet been developed.

### SUMMARY OF THE INVENTION

The present invention has been conceived in light of the problems of the related art described above, and an object thereof is to provide a wheel cover that can improve the display performance of electric decoration.

In order to achieve the object described above, a wheel cover according to the present invention includes a wheel-cover main body, a power supply, and an electric decorator. The electric decorator includes a display plate and a light source.

The wheel cover main body is mounted to a wheel and rotates together with the wheel.

The electric decorator is supported so as to be rotatable relative to the wheel-cover main body in such a manner that it substantially does not rotate with the rotation of the wheel-cover main body.

The power supply supplies electrical power to the electric decorator.

The display plate includes a base member having a desired optical transparency and refractive index n₁. A characteristic portion with a refractive index n₂ smaller than the refractive index n₁ of the base member (n₁>n₂) is formed in the base member.

The light source emits light when supplied with electrical power from the power supply, and this light passes through the interior of the display plate with the refractive index n₁.

With this wheel cover, the characteristic portion of the display plate is made to shine intensely with the internal illumination of the display plate by the light source, compared with a non-characteristic portion of the base member.

The desired optical transparency mentioned here means optical transparency of the display plate with respect to the light from the light source.

In the present invention, the wheel cover may be configured such that the display plate includes an acrylic resin plate having the optical transparency and refractive index n₁ mentioned above; the characteristic portion includes a concave portion formed by engraving the acrylic resin plate; and the refractive index n₂ of the characteristic portion is the refractive index of air filling the concave portion formed by engraving the display plate.

In the present invention, the wheel cover may be configured such that the engraving is applied to a rear of the display plate; the light source is disposed at a side of the display plate; and the internal illumination of the display plate by the light source is performed laterally relative to the display plate.

In the present invention, it is preferable to comprise a side-face reflecting member.

The side-face reflecting member is disposed so as to cover a side face of the display plate and prevents leakage of the light inside the display plate to the outside via the side face of the display plate.

In the present invention, it is preferable to comprise a rear-face reflecting member.

The rear-face reflecting member is disposed so as to cover a rear face of the display plate, to which the engraving is applied, and prevents leakage of the light inside the display plate to the outside via the rear face of the display plate.

In the present invention, the wheel cover may be configured such that the display plate is a spoke-shaped display plate; and the characteristic portion of the display plate is provided on the entire surface of the spoked-shaped display plate.

In the present invention, the wheel cover may be configured such that the characteristic portion of the display plate comprises minute indentations and projections formed on the entire surface of the spoke-shaped display plate.

The spoke-shaped display plate of the present invention is indirectly provided on the wheel, with the wheel cover therebetween; that is to say, it includes a display plate provided on the wheel cover and a display plate directly connected to the wheel.

In the present invention, the wheel cover may be configured such that the light source comprises a light-emitting device; the power supply comprises a generator for generating electrical power in response to rotation of the wheel cover. The generator comprises a generator rotating shaft which rotates together with the wheel-cover main body, and a generator main body which is supported so as to be rotatable relative to the wheel-cover main body and which generates electrical power by rotation of the generator rotating shaft, the generator main body substantially does not rotate due to rotation of the wheel-cover main body.

In the present invention, it is preferable to comprise a weight and a stopper.

The weight is provided so as to be movable relative to the electric decorator within a predetermined range in a vertical plane parallel to a rotation plane of the wheel cover, at a point shifted from a center of the electric decorator.

The stopper is fixed to the electric decorator and restricts the range of relative motion of the weight with respect to the electric decorator when abutting against the weight.

Effect

With the wheel cover according to the present invention, the characteristic portion of the display plate is made to shine intensely with the internal illumination of the display plate by the light source, compared with the non-characteristic portion. Therefore, it is possible to improve the display performance of the electric decoration using a simple configuration.

In the present invention, by including a concave portion in the display plate, formed by subjecting the acrylic resin plate to engraving, it is possible to more reliably improve the display performance of the electric decoration.

In the present invention, by subjecting the rear of the display plate to engraving and performing internal illumination of the display plate laterally with respect to the display plate using the light source, it is possible to more reliably improve the display performance of the electric decoration.

In the present invention, by providing a side-face reflecting member at a side face of the display plate or a rear-face reflecting member at a rear face of the display plate, the display plate being subjected to engraving, it is possible to more reliably improve the display performance of the electric decoration.

In the present invention, by using a spoke-shaped display plate and by providing the characteristic portion on the entire front portion of the spoke-shaped display plate, it is possible to make the spoke portions of the spoked wheel shine intensely.

In the present invention, by forming minute indentations and projections on the entire front portion of the spoke-shaped display plate to serve as the characteristic portion of the display plate, it is possible to make the spoke portions of the spoked wheel shine even more intensely.

In the present invention, by including light-emitting devices in the light source and by including in the power supply a generator provided with a generator main body that substantially does not rotate due to the rotation of the wheel cover, it is possible to more reliably improve the display performance of the electric decoration.

In the present invention, by providing a weight that can move within a predetermined range relative to the electric decorator and a stopper that is fixed to the electric decorator and that abuts against the weight to restrict the range of relative motion of the weight with respect to the electric decorator, it is possible to reliably supply electrical power to the electric decorator. Furthermore, it is possible to reliably achieve the desired display performance of the electric decoration.

### BRIEF DESCRIPTION OF THE DRAWINGS

FIG. 1 is a side view of a wheel using a wheel cover according to an embodiment of the present invention.

FIG. 2 is a rear view of the wheel cover according to the embodiment of the present invention.

FIG. 3 is a view for explaining internal illumination of the wheel cover according to the embodiment of the present invention.

4 is a front view showing the internal illumination of the wheel cover according to the embodiment of the present invention.

FIGS. 5A, 5B, and 5C show a modification (center cap) of the wheel cover according to an embodiment of the present invention.

FIGS. 6A and 6B show a modification (spoked wheel) of the wheel cover according to an embodiment of the present invention.

FIGS. 7A and 7B are views illustrating the structure of a movable weight employed in the wheel cover according to an embodiment of the present invention.

FIGS. 8A, 8B, and 8C are views for explaining the operation of the movable weight shown in FIGS. 7A and 7B.

### DESCRIPTION OF THE PREFERRED EMBODIMENT

Preferred embodiments of the present invention will be described below with reference to the drawings.

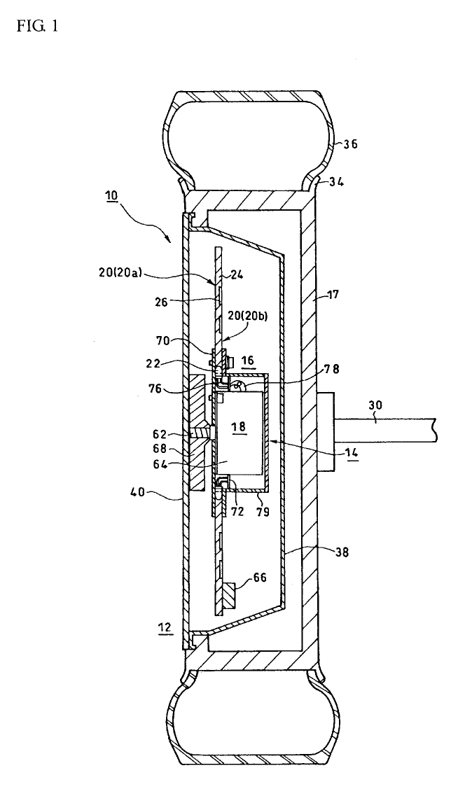

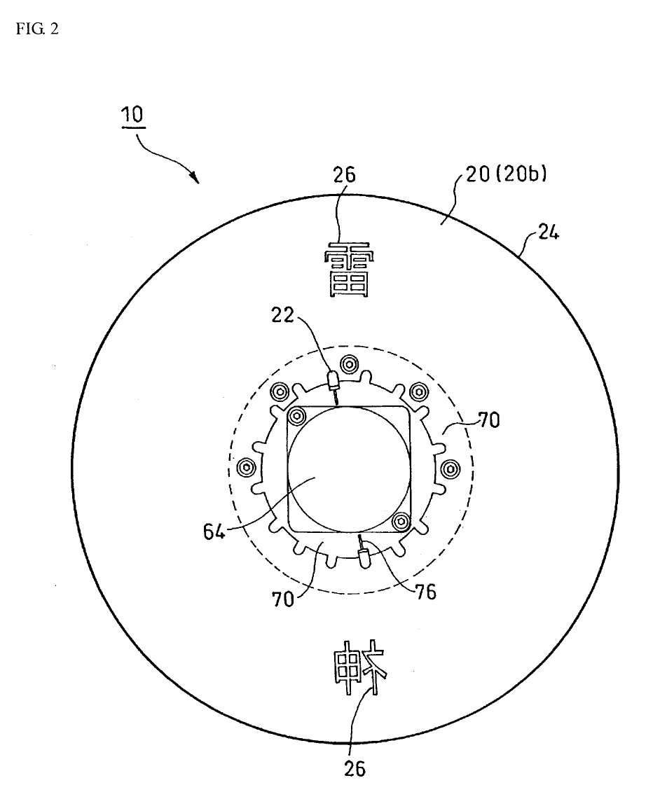

FIGS. 1 and 2 illustrate an outline configuration of a wheel cover 10 according to an embodiment of the present invention. FIG. 1 is a side view of a wheel using the wheel cover 10 according to this embodiment, and FIG. 2 is a rear view of the wheel cover 10.

In these figures, the wheel cover 10 includes a wheel-cover main body 12, a power supply 14, and electric decorator 16.

The wheel-cover main body 12 is mounted to a wheel 17 for an automobile tire and rotates together with the wheel 17.

The power supply 14 includes a generator 18. The generator 18 generates electrical power by rotation of the wheel-cover main body 12 and supplies this electrical power to the electric decorator 16.

The electric decorator 16 is supported so as to be rotatable relative to the wheel-cover main body 12 in such a manner that it does not substantially rotate due to the rotation of the wheel-cover main body 12.

The electric decorator 16 includes a display plate 20 and light sources 22, which is a feature of the present invention.

The display plate 20 includes a base member 24 and characteristic portions 26. The base member 24 is optically transparent to light from the light sources 22 and has a refractive index n₁, and the characteristic portions 26 have a refractive index n₂ that is smaller than the refractive index n₁, of the base member 24 (that is, n₁>n₂).

The light sources 22 include light-emitting devices (LEDs). The light sources 22 output light when supplied with electrical power from the power supply 14, and this light is transmitted inside the display plate 20.

The structure of the wheel cover 10 according to this embodiment will be described more concretely below.

Wheel-cover Main Body

In this embodiment, a tire 36 is mounted on a rim 34 of the wheel 17, which rotates together with an axle 30 of the automobile.

The wheel cover 10 of this embodiment is mounted to the outer side of the wheel 17 to serve as a full-wheel cap.

The wheel-cover main body 12 includes a frame member 38 and a front cover 40.

The frame member 38 is mounted to the wheel 17.

The front cover 40 is provided on the frame member 38. In order for the front cover 40 to transmit illumination light coming from the display plate 20, emitted by the light sources 22, to outside the wheel cover 10, it is optically transparent to the illumination light.

In this embodiment, it is preferred that the front cover 40 also function as a lens. It is also preferable that the front cover 40 modulate the illumination light coming from the display plate 20, emitted by the light sources 22, to a desired magnitude and transmit it to outside the front cover 40.

Electric Decorator

In this embodiment, an acrylic resin plate is used as the display plate 20.

Letters or images engraved in the base member 24 of the display plate 20 serve as the characteristic portions 26 of the display plate 20.

The refractive index n₂ of the characteristic portions 26 in the display plate 20 correspond to the refractive index of air filling the indentations (concave portion) formed in the display plate 20 by the engraving process.

From among a plurality of possible machining positions, the rear face 20b of the display plate 20 is selected to form the characteristic portions 26, which serve as letters or images engraved.

The light sources 22 are provided at an inner circumferential wall of the display plate 20, which is donut-shaped. The light sources 22 perform illumination from the inner wall of the display plate 20 towards the interior of the display plate 20.

Light Source and Power Supply

In this embodiment, from among a plurality of light sources, low-power-consumption light-emitting devices (LEDs) are selected as the light sources 22 of the wheel cover 10. From among a plurality of power supplies, the generator 18 is selected as the power supply 14 of the wheel cover 10.

The generator 18 includes a generator rotating shaft 62, a generator main body 64, and a generator weight 66.

The generator rotating shaft 62 is disposed so as to be rotatable relative to the generator main body 64. This generator rotating shaft 62 is fixed at the center of the rear face of the front cover 40, by means of a shaft holder 68.

The generator weight 66 is disposed at the bottom of the rear face of the display plate 20.

The generator main body 64 is supported so as to be rotatable relative to the wheel-cover main body 12. Therefore, the generator rotating shaft 62 rotates due to the rotation of the wheel-cover main body 12, but the generator main body 64 substantially does not rotate due to the rotation of the wheel-cover main body 12. Relative rotary motion is produced between the generator rotating shaft 62 and the generator main body 64 in the generator 18, thus generating electrical power.

In this embodiment, the front surface 20a of the display plate 20 is fixed to the generator main body 64 via a ring plate 70.

A base plate 72 is mechanically secured to the generator main body 64.

The interior of the generator main body 64 and the base plate 72 are electrically connected via electrical wires 78. The base plate 72 and electrodes 76 of the light sources 22 are electrically connected.

Accordingly, the electrical power produced by the generator 18 is supplied to the electrodes 76 via the base plate 72, which causes the light sources 22 to emit light.

A watertight cover 79 is secured to the rear face of the display plate 20 to cover the power supply 14 from the rear.

The operation of the wheel cover 10 according to this embodiment, having the configuration outlined above, will be described below.

In this embodiment, when the wheel 17 rotates, the wheel-cover main body 12 rotates together, the generator 18 produces electrical power, and the light sources 22 illuminate.

Light 80 from the light sources 22 passes through the interior of the display plate 20 and makes the engraved letters or images, which are the characteristic portions 26, shine intensely and stand out. In this embodiment, it is possible to improve the display performance of the electric decoration with such internal illumination of the display plate 20 by the light sources 22.

In other words, from among a plurality of possible materials, an acrylic resin plate, which has excellent optical characteristics and in which the characteristic portions can be easily machined, is selected as the display plate 20 in this embodiment.

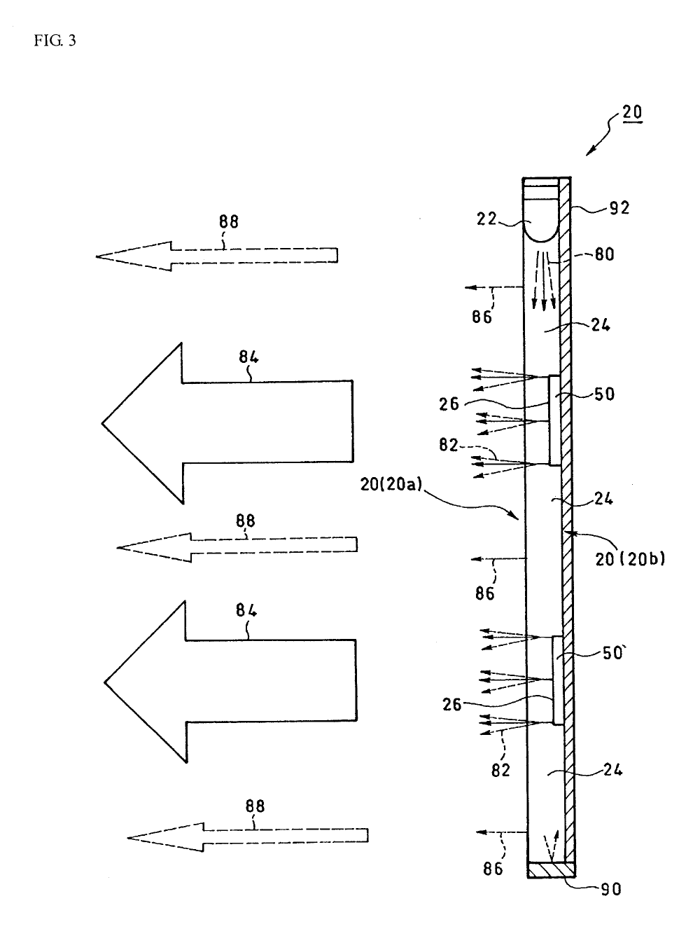

The base member 24, which has the desired optical transparency and refractive index n₁, is subjected to engraving to form the characteristic portions 26 of the display plate 20. The refractive index n₂ of the characteristic portions 26 in the display plate 20 corresponds to the refractive index of air 50 filling the indentations engraved in the display plate 20, as shown in FIG. 3.

Non-characteristic portions (non-engraved portions) of the base member 24 in the display plate 20 have no refractive index difference, and therefore, the light 80 inside the display plate 20 continues to propagate (be transmitted) inside the display plate 20. Of the light 80 inside the display plate 20, transmitted light 86 from the non-characteristic portions of the base member 24 is emitted from the display plate 20. When viewing this transmitted light 86 from the front of the wheel cover 10, it is observed as non-characteristic light 88.

On the other hand, the refractive index difference inside the display plate 20 at the interfaces of the characteristic portions 26, such as letters or images, and the non-characteristic portions of the base member 24 is large. Therefore, when the light 80 inside the display plate 20 is incident on the characteristic portions 26 having the refractive index n₂ from non-characteristic portions of the base member 24 having the refractive index n₁, it is diffusely reflected at the interfaces (edge portions).

Scattered light 82 at the characteristic portions 26 in the base member 24 is emitted towards the front of the wheel, from the front surface 20a of the display plate 20. When viewing the wheel cover 10 from the front, this scattered light 82 is observed as extremely bright characteristic light 84 that enhances edges.

As a result, when someone looks at the wheel cover 10 of this embodiment from the front, the characteristic light 84 at the characteristic portions 26 of the display plate 20 is more intense than the transmitted light 86 at the non-characteristic portions of the base member 24, with the internal illumination of the display plate 20.

Reflecting Member

In order to more reliably achieve the desired display performance of the electric decoration in this embodiment, it is important to use the light effectively. Therefore, it is extremely important to provide a reflecting member.

More specifically, in this embodiment, a side-face reflecting seal (side-face reflecting member) 90 or a rear-face reflecting seal (rear-face reflecting member) 92 is preferably provided.

The side-face reflecting seal 90 is provided on a side face of the display plate 20. This side-face reflecting seal 90 prevents the light 80 inside the display plate 20 from leaking outside via the side face of the display plate 20.

The rear-face reflecting seal 92 is provided to cover the rear face of the display plate 20, which is subjected to engraving. This rear-face reflecting seal 92 prevents the light 80 inside the display plate 20 from leaking outside via the rear face of the display plate 20.

As a result, in this embodiment, because it is possible to prevent wasteful light leakage in directions other than the direction (toward the front of the wheel cover) opposite the viewing direction of the illumination using the reflecting seals 90 and 92, the light 80 from the light sources 22 can be used efficiently.

With this embodiment, therefore, in the illumination viewing direction (when viewed from the front surface of the wheel cover), it is possible to make the characteristic portions 26 of the display plate 20 shine more intensely than the non-characteristic portions of the base member 24 with the internal illumination of the display plate 20 by the light sources 22. Therefore, this embodiment can more reliably provide the desired display performance of the electric decoration compared with a configuration in which efficient use of the light in this manner is not considered.

Characteristic Portions

In order to more reliably achieve the desired display performance of the electric decoration in this embodiment, selection of the display plate and selection of the method of machining the characteristic portions in the display plate are also extremely important.

Therefore, an acrylic resin plate, which has the required optical characteristics for obtaining sufficient illumination of the wheel cover 10 in this embodiment and excellent machinability, is employed as the display plate 20 in this embodiment.

Engraving, which features the ability to obtain sharper edges in the characteristic portions, such as letters or images, is selected as the method of machining the characteristic portions 26 of the display plate 20 in this embodiment.

As a result, it is possible to more reliably improve the display performance of the electric decoration compared with an approach in which no consideration is made about the display plate and the method of machining the characteristic portions in the display plate.

Characteristic-portion Machining Position and Illumination Position

In order to more reliably achieve the desired display performance of the electric decoration in this embodiment, selection of the machining positions of the characteristic portions and selection of the illumination positions are extremely important.

Therefore, in this embodiment, the rear face of the display plate 20 is subjected to engraving.

The light sources 22 are provided at a side of the display plate 20.

Therefore, by performing the internal illumination of the display plate 20 laterally with respect to the display plate 20 using the light sources 22, it is possible to reliably achieve more uniform illumination of the non-characteristic portions of the base member 24 at the front surface of the display plate 20, compared with configurations in which the light sources 22 are disposed at other positions with respect to the display plate 20.

Furthermore, because the rear face of the display plate 20 is subjected to engraving, the scattered light 82 emerging from the display plate 20 is more reliably concentrated in the direction opposite the viewing direction of the wheel cover (toward the front surface of the wheel cover).

Therefore, at the front surface of the display plate 20, it is possible to reliably see the letters clearly at the characteristic portions in the more uniform illumination of the non-characteristic portion, compared with cases in which engraving is performed at other positions or the light sources 22 are disposed at other positions with respect to the display plate 20.

Therefore, in this embodiment, it is possible to more reliably achieve improved display performance of the electric decoration compared with a case in which no consideration is made about the machining position of the characteristic portions and the illumination position.

Light Sources and Power Supply

Selection of the light sources and the power supply is extremely important to reliably achieve the desired display performance of the electric decoration.

Therefore, in this embodiment, from among a plurality of light sources, low-power-consumption, high-brightness light-emitting devices (LEDs) are selected as the light sources 22 of the wheel cover 10.

In addition, from among a plurality of power supplies, the generator 18 is selected as the power supply 14 of the wheel cover 10 in this embodiment. The generator 18 has excellent compactness, is lightweight, does not require wires from outside the wheel cover, and can ensure reliable electrical power supply.

The generator 18 includes the generator rotating shaft 62, which rotates together with the wheel-cover main body 12, and the generator main body 64, which is supported so as to be rotatable relative to the wheel-cover main body 12 and which generates electrical power as the generator rotating shaft 62 rotates. Hence, the generator main body 64 substantially does not rotate with the rotation of the wheel-cover main body 12.

As a result, it is possible to ensure the reliable supply of electrical power with a simple configuration.

Therefore, it is possible to reliably perform internal illumination of the display plate 20 with the light sources 22, which is a feature of this embodiment.

It is possible to more reliably achieve the desired display performance of the electric decoration compared with a case in which no consideration is made about the light sources and the power supply.

By configuring the wheel cover 10 according to this embodiment in this way, when viewing the wheel cover 10 from the front surface thereof, although the tire 36 and the wheel-cover main body 12 rotate, the display plate 20 is stationary, as shown in FIG. 4. The characteristic light 84 at the engraved portions shines intensely in the uniform non-characteristic light 88 at the non-engraved portions of the base member, thus clearly standing out. Therefore, the observer can clearly see the letters or images formed by the characteristic light 84.

In this embodiment, it is possible to provide the light sources at positions other than at the side of the display plate, so long as it is still possible for the characteristic portions to shine intensely with the internal illumination of the display plate. In this embodiment, however, the side of the display plate is particularly preferable for obtaining more-uniform internal illumination in the display plate.

The characteristic portions may be located at positions other than the rear face of the display plate so long as it is possible to make the characteristic portions shine intensely with the internal illumination in the display plate. In this embodiment, however, to allow the characteristic portions to shine intensely with the internal illumination of the display plate, the rear face of the display plate is particularly preferable.

It is possible to use any combination of the positions (illumination direction) of the light sources and the positions of the characteristic portions in the display plate, so long as it is possible to make the edge portions shine intensely with the internal illumination in the display plate. In this embodiment, however, to allow the characteristic portions to intensely shine in the uniform internal illumination from the display plate, a combination of side illumination of the display plate using the light sources and providing the characteristic portions on the rear face of the display plate is particularly preferable.

Modifications

In the configurations described above, an example is given in which the wheel cover of this embodiment is used as a full wheel cap; however, the present invention is not limited thereto. It is preferable to use the wheel cover as a center cap or to make the wheel itself with the wheel cover of this embodiment.

Center Cap

In the configuration described above, an example is described in which an outer peripheral portion close to the outer edge than to the center portion of the wheel cover is made to shine; however, the present invention is not limited thereto. A configuration in which the center portion is made to shine is preferable; that is, it is also preferable to use the wheel cover of this invention as a center cap.

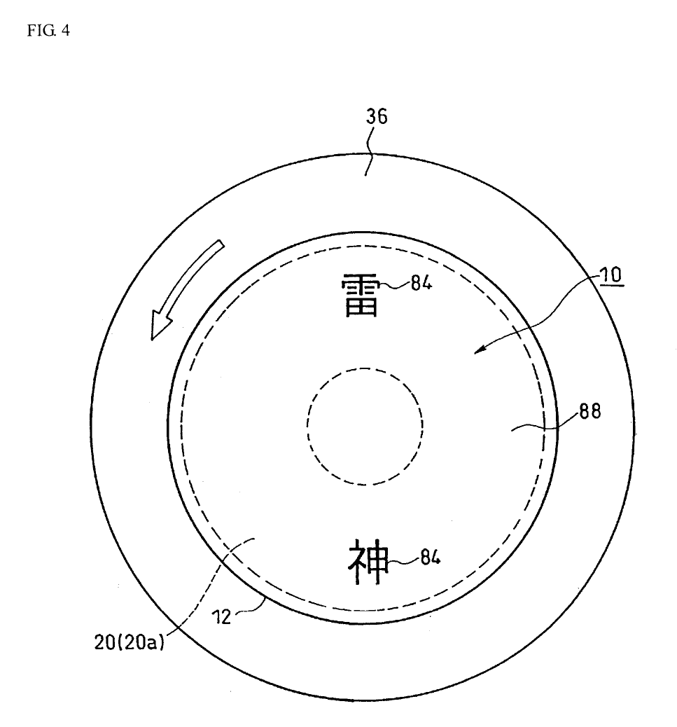

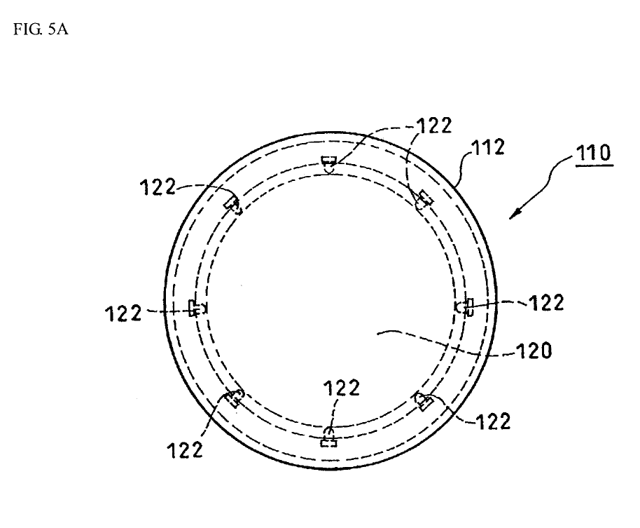

FIGS. 5A, 5B, and 5C illustrate an outline configuration of a case in which a wheel cover according to an embodiment of the present invention is used as a center cap 110. FIG. 5A is a front view of the center cap 110 according to the embodiment of the present invention, and FIG. 5B is a side view of the center cap. Parts that correspond to those in the configurations described above are indicated by the same reference numerals, plus 100, and a description thereof is omitted here.

The center cap (wheel cover) 110 shown in these figures is mounted to the center portion of a wheel. This center cap 110 includes a center-cap main body 112 which rotates together with the wheel and a disc-shaped display plate 120 which is supported so as to be rotatable relative to the center-cap main body 112 in such a manner that it does not rotate due to the rotation of the center-cap main body 112.

In this embodiment, in order to perform internal illumination of the center cap 110, a plurality of light sources (LEDs) 122 are disposed at regular intervals around the outer circumferential wall of the display plate 120 such that the propagating directions of the light beams therefrom are towards the center of the center-cap main body 112.

When the wheel rotates, the center-cap main body 112 rotates, whereas the electric decorator that includes the display plate 120, the light sources 122, and so forth and a generator main body 164 remain stationary. Thus, a generator rotating shaft 162 rotates together with the center-cap main body 112 relative to the generator main body 164. The electrical power thus produced is supplied to the light sources 122.

As a result, the entire display plate 120 of the center cap 110 shines. Particularly, the characteristic portions shine intensely.

When an observer views the center cap 110 from the front, as shown for example in FIG. 5C, the tire 136 and the center-cap main body 112 rotate; however, with the display plate 120 remaining stationary, characteristic light 184 shines intensely at the characteristic portions, thus making it stand out in uniform non-characteristic light 188 at non-characteristic portions. Therefore, on the center cap 110, the observer can clearly see a letter or an image in the characteristic light 184.

Therefore, it is possible to improve the electric decoration performance of the center cap 110.

In the center cap 110 shown in FIGS. 5A to 5C, a weight may be incorporated inside the generator main body 164 or it may be provided on the exterior of the generator main body 164.

In the configuration shown in FIGS. 5A to 5C, when the generator main body 164 freely rotates together with the center-cap main body 112, it is preferable that a weight be provided on the generator rotating shaft 162.

Spoked Wheel

The above configurations have been described in terms of an example in which the display plate of the wheel cover is a substantially circular plate; however, the present invention is not limited thereto. It is also preferable to use a spoked configuration.

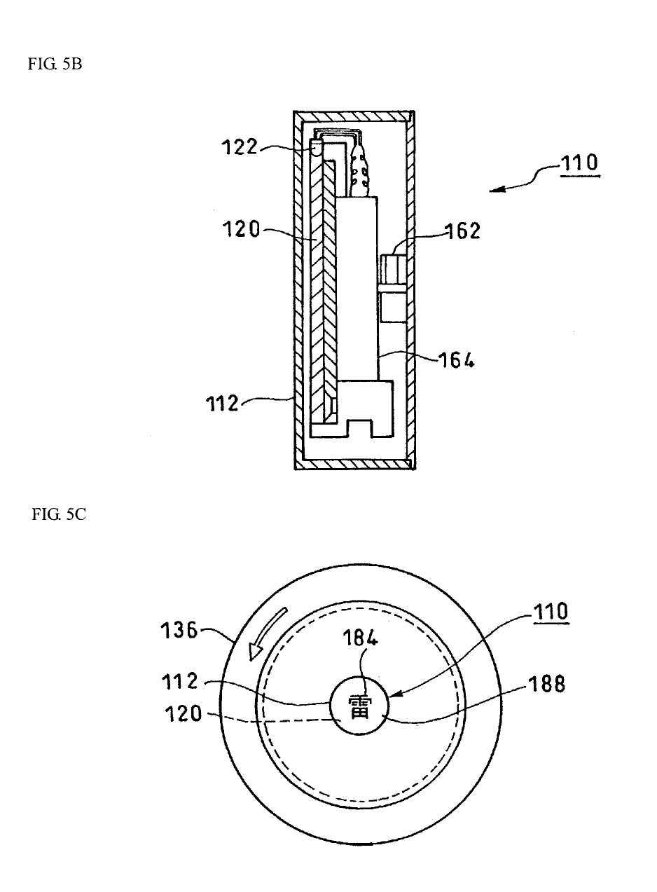

In this embodiment, it is preferable to constitute the tire wheel itself in the wheel cover. For example, it is preferable to use the present invention in a spoked wheel, such as that shown in FIGS. 6A and 6B. Parts corresponding to those of the configurations described above are assigned the same reference numerals, plus 200, and a description thereof is omitted here.

FIGS. 6A and 6B illustrate an outline configuration of a spoked wheel according to this embodiment. FIG. 6A is a front view of the spoked wheel, and FIG. 6B is a side view of a spoke portion. The front surface (front portion) of the spoke portion points upwards in the drawing.

A spoked wheel (wheel cover) 210 shown in the figure includes a plurality of (for example, five) spoke portions 295, and spoke-shaped display plates 220 corresponding thereto are provided along the respective spoke portions 295.

Minute indentations and projections are formed on the entire front portion (at the front-surface side of the wheel) of the spoke-shaped display plates 220 to serve as characteristic portions in the display plates 220, for example, minute indentations and projections like those on ground glass.

These minute indentations and projections are not provided in the rear or side portions of the display plates 220; they are provided only on the front of the display plates 220.

To perform internal illumination in the spoke-shaped display plates 220 in this embodiment, corresponding light sources (LEDs) 222 are disposed in the center-side end faces of the spoke-shaped display plates 220. The directions in which light travels are from the center-side end faces of the spoke-shaped display plates 220 towards the outer-circumference-side end faces thereof.

As a result, because the spoke-shaped display plates 220 shine due to rotation of the spoked wheel 210, it is possible to make the spoke portions 295 shine intensely.

In other words, in this embodiment, the minute indentations and projections serving as the characteristic portions of the display plates 220 are not provided on the rear or the side of the display plates 220; they are provided only on the front of the display plates 220.

Therefore, as shown in FIG. 6B, substantially none of the light passing through the interior of the display plate 220 is emitted from the rear and side faces, which are faces other than the front faces of the spoke-shaped display plates 220; most of it is emitted only from the front 220a.

Therefore, in this embodiment, because it is possible to efficiently make the spoke portions 295 of the spoked wheel 210 shine intensely, the electric decoration performance of the spoked wheel 210 can be further improved.

In order to improve the electric decoration performance of the spoked wheel 210, it is possible to provide another electric decorator on the spoke portions 295 of the spoked wheel 210; however, the spoked wheel 210 shown in the figure is extremely advantageous in terms of both the electric decorator performance and simplified construction of the electric decorator.

In other words, to improve the electric decoration performance of the spoked wheel, it has normally been considered to arrange a plurality of light sources in a straight line, from the inner ends of the spoke portions of the spoked wheel to the outer ends thereof.

However, providing a plurality of light sources in a straight line makes it difficult to dispose a power supply mechanism on the wheel. For example, it is difficult to dispose wirings, boards, etc. for supplying power to each light source on the wheel. This problem is particularly severe in a spoked wheel, where space is limited, compared with a standard disc-shaped wheel.

Furthermore, by arranging a plurality of light sources in a straight line, the illumination comes from points, and it is not possible to obtain satisfactory electric decoration performance.

In contrast, this embodiment uses the internal illumination of the spoke-type display plates 220 to achieve superior electric decoration performance as well as a very simplified construction of the electric decorator.

Movable Weight

In order to reliably achieve the desired display performance of the electric decoration, it is also extremely important to reliably supply electrical power.

In this embodiment, a generator that generates electrical power by rotation of the wheel cover is used as the power supply. With a configuration using a generator, it is extremely advantageous to add a weight to the generator main body, at the stationary side of the generator, or to the rotating shaft of the generator.

The weight used here is a standard fixed weight and is fixed to the display plate, for example.

However, by attaching a fixed weight to the display plate, when the tire rotates at a constant rotational speed, magnetic forces that attract the generator main body and the rotary shaft of the generator each other and a gravitational force that tends to maintain the central position of the weight occur, causing resonance.

In contrast, in this embodiment, in order to prevent resonance such as that described above, a weight possessing dead-weight which can exert a force even stronger than the forces attracting the generator main body and the generator rotary shaft each other is accommodated inside a case fixed to electric decorator, including the display plate and so on, in such a manner as to be movable.

In this embodiment, by using such a movable weight, it is possible for the electric decorator, including the display plate and so on, to greatly reduce vibrations to the left and right, compared with a configuration in which a fixed weight is used. Therefore, it is possible to reliably supply electrical power from the generator.

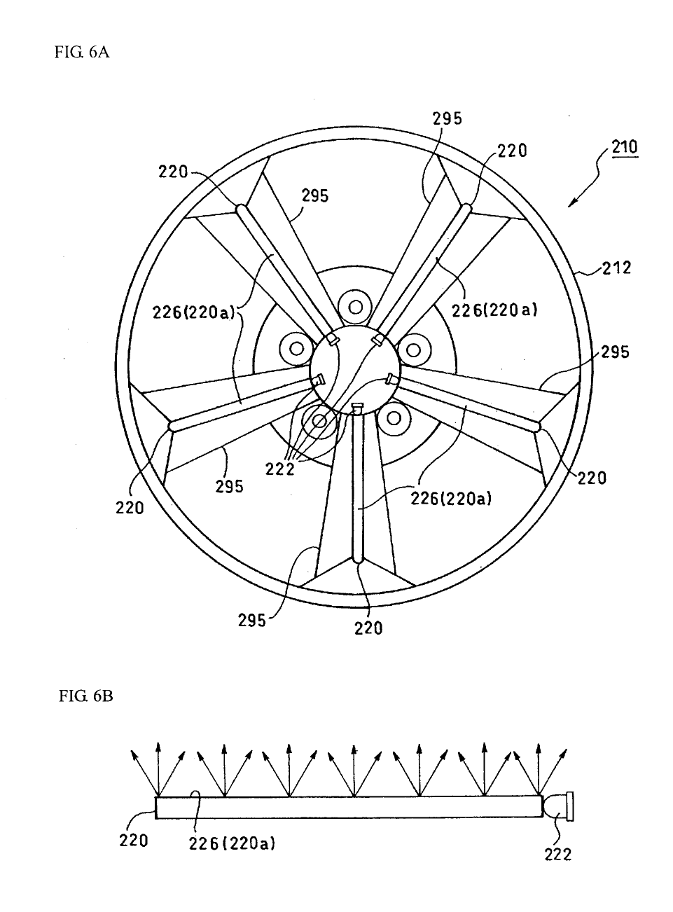

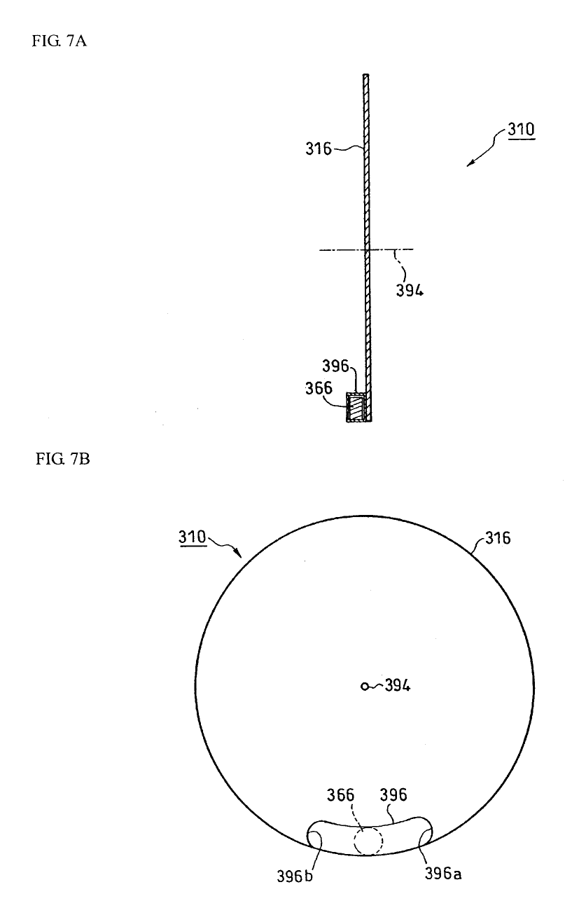

FIGS. 7A and 7B illustrate an outline configuration of a preferable movable weight used in a wheel cover according to this embodiment. FIG. 7A is a longitudinal sectional view of a vicinity of the movable weight, and FIG. 7B is a view from the front or rear of the vicinity of the movable weight. Parts corresponding to the configurations described above are indicated by the same reference numerals, plus 300, and a description thereof is omitted.

A feature of the present invention is the use of a movable weight such as that shown in FIGS. 7A and 7B. Therefore, in this embodiment, a weight 366 and a case-like stopper (stopper) 396 are provided.

The weight 366 is disposed so as to freely move relative to electric decorator 316, including a display plate and so on, within a predetermined range in a vertical plane parallel to the rotation plane of the wheel-cover main body, at a position shifted from a central axis 394 of the electric decorator 316.

The case-like stopper (stopper) 396 is fixed to the electric decorator 316 and abuts against the weight 366, thus limiting the range of relative motion of the weight 366 with respect to the electric decorator 316.

As a result, even if rotation occurs in the electric decorator 316, including the display plate and so on, due to the effect described above, the weight 366 moves inside the case-like stopper 396 according to the vibration direction of the electric decorator 316 and abuts against one end 396a or another end 396b of the case-like stopper 396. This allows a force that counteracts rotation of the electric decorator 316 to be exerted on the case-like stopper 396. Thus, in this embodiment, because a force that counteracts the rotation of the electric decorator 316 is exerted, vibration of the electric decorator 316 can be reliably suppressed, and the electric decorator 316, including the display plate and so on, can be kept stable.

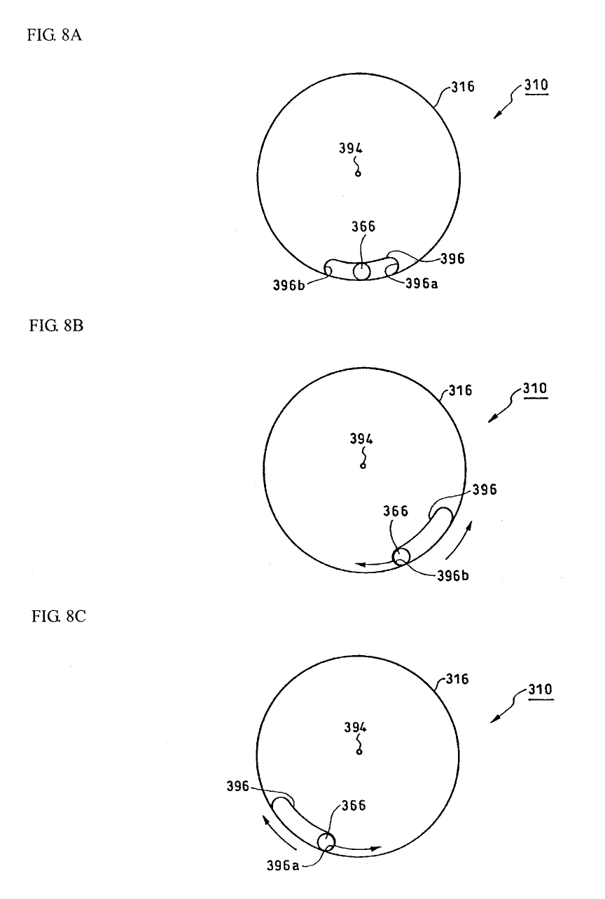

The operation of the movable weight 366 will be described in more detail below with reference to FIGS. 8A to 8C.

FIG. 8A shows the stationary state of the electric decorator 316, FIG. 8B shows the electric decorator 316 rotated counter-clockwise, and FIG. 8C shows the electric decorator 316 rotated clockwise.

In the stationary state of the electric decorator 316, as shown in FIG. 8A, the weight 366 is stationary at a central position inside the case-like stopper 396.

As shown in FIG. 8B, when the electric decorator 316 rotates in the counter-clockwise direction, the relative position of the weight 366 inside the case-like stopper 396 moves in the clockwise direction, and the weight 366 and the other end 396b of the case-like stopper 396 abut against each other. This exerts a force that suppresses rotation of the electric decorator 316, which tends to rotate in the counter-clockwise direction. Therefore, it is possible to rapidly bring about the stationary state of the electric decorator 316, including the display plate and so on, as shown in FIG. 8A.

As shown in FIG. 8C, when the electric decorator 316 rotates clockwise, the relative position of the weight 366 inside the case-like stopper 396 moves in the counter-clockwise direction, and the weight 366 and the one end 396a of the case-like stopper 396 abut against each other. This exerts a force that suppresses rotation of the electric decorator 316, which tends to rotate clockwise. Therefore, it is possible to rapidly bring about the stationary state of the electric decorator 316, including the display plate and so on, as shown in FIG. 8A.

In these figures, as an example, the weight 366 is illustrated as a solid object; however, so long as it allows the stationary state of the electric decorator 316, including the display plate and so on, to be maintained, it is also possible to use a liquid, such as water, inside the case-like stopper 396.

What is claimed is:

1. A wheel cover comprising:
a wheel-cover main body which is mounted to a wheel and which rotates together with the wheel;
an electric decorator supported so as to be rotatable relative to the wheel-cover main body in such a manner as to substantially not rotate due to rotation of the wheel-cover main body; and
a power supply for supplying electrical power to the electric decorator,
wherein the electric decorator comprises
a display plate having a base member with a desired optical transparency and a refractive index n₁, a characteristic portion having a refractive index n₂ smaller than the refractive index n₁ (n₁>n₂) of the base member being formed in the base member, and
a light source for emitting light when supplied with the electrical power from the power supply and for transmitting the light through the interior of the display plate, and
the characteristic portion of the display plate shines more intensely with internal illumination of the display plate by the light source than a non-characteristic portion of the base member.

2. A wheel cover according to claim 1, wherein:
the display plate comprises an acrylic resin plate having the optical transparency and refractive index n₁;
the characteristic portion of the display plate comprises a concave portion which is engraved in the acrylic resin plate; and
the refractive index n₂ of the characteristic portion is the refractive index of air filling the concave portion formed by engraving the display plate.

3. A wheel cover according to claim 2, wherein:
the engraving is applied to a rear of the display plate;
the light source is disposed at a side of the display plate; and
the internal illumination of the display plate by the light source is performed laterally relative to the display plate.

4. A wheel cover according to claim 3, further comprising:
a side-face reflecting member disposed so as to cover a side face of the display plate, for preventing leakage of the light inside the display plate to the outside via the side face of the display plate.

5. A wheel cover according to claim 3, further comprising:
a rear-face reflecting member disposed so as to cover a rear face of the display plate, to which the engraving is applied, for preventing leakage of the light inside the display plate to the outside via the rear face of the display plate.

6. A wheel cover according to claim 1, wherein:
the display plate is a spoke-shaped display plate; and
the characteristic portion of the display plate is provided on the entire surface of the spoked-shaped display plate.

7. A wheel cover according to claim 6, wherein the characteristic portion of the display plate comprises minute indentations and projections formed on the entire surface of the spoke-shaped display plate.

8. A wheel cover according to claim 1, wherein:
the light source comprises a light-emitting device;
the power supply comprises a generator for generating electrical power in response to rotation of the wheel cover;
the generator comprises
a generator rotating shaft which rotates together with the wheel-cover main body, and
a generator main body which is supported so as to be rotatable relative to the wheel-cover main body and which generates electrical power by rotation of the generator rotating shaft; and
the generator main body substantially does not rotate due to rotation of the wheel-cover main body.

9. A wheel cover according to claim 8, further comprising:
a weight provided so as to be movable relative to the electric decorator within a predetermined range in a vertical plane parallel to a rotation plane of the wheel cover, at a point shifted from a center of the electric decorator; and
a stopper fixed to the electric decorator, for restricting the range of relative motion of the weight with respect to the electric decorator when abutting against the weight.
